(19) United States
(12) Patent Application Publication
(10) Pub. No.: US 2021/0358435 A1
(43) Pub. Date: Nov. 18, 2021

(54) DISPLAY DEVICE, METHOD OF DRIVING DISPLAY, AND FINGERPRINT RECOGNITION SYSTEM WITHIN THE DISPLAY

(71) Applicant: HON HAI PRECISION INDUSTRY CO., LTD., New Taipei (TW)

(72) Inventors: KUO-SHENG LEE, New Taipei (TW); CHUN-CHI LEE, New Taipei (TW); WEN-PO KO, New Taipei (TW)

(21) Appl. No.: 16/904,850

(22) Filed: Jun. 18, 2020

(30) Foreign Application Priority Data
May 15, 2020 (CN) 202010411405.X

(51) Int. Cl. G09G 3/36; G02F 1/1333; G06K 9/00

(52) U.S. Cl. CPC G09G 3/3648; G09G 2310/0264; G06K 9/00013; G02F 1/13338

(57) ABSTRACT

A method applied to a display device for displaying images divides the display device into a first display area and a second display area. The method drives the first display area and the second display area to display images during a first driving period, and during a second driving period drives the first display area to keep displaying a most recent image. During the second driving period at least a part of the second display area is driven to display a white image, and the overall second display area is driven to accept and recognize fingerprints if and when a recognition-start signal is received during the second driving period. The first and second display areas are driven to again display images when a recognition-end signal is received during a third driving period. The display device is also provided.

### FIELD

The subject matter herein generally relates to human-computer interfaces, particularly a driving method of a display device and the display device using the driving method.

### BACKGROUND

Some display devices can both display images and recognize fingerprints. Such a display device generally includes a thin film transistor substrate, a fingerprint recognition circuit provided on the thin film transistor substrate, and a liquid crystal layer. The thin film transistor substrate outputs signals to drive the liquid crystal layer to display images. The fingerprint recognition circuit outputs signals as to fingerprint impressions. Signals to be recognized as fingerprints may be affected by the display signals and lose accuracy.

Therefore, there is room for improvement in the art.

### BRIEF DESCRIPTION OF THE DRAWINGS

Implementations of the present disclosure will now be described, by way of embodiment, with reference to the attached figures.

FIG. 1 is a planar view of a display device according to an embodiment of the present disclosure.

FIG. 2 is a cross-sectional view of the display device shown in FIG. 1.

FIG. 3 is a planar view of a driving substrate of the display device shown in FIG. 2.

FIG. 4 is a schematic diagram of a display circuit in a pixel in a first display area of the display device.

FIG. 5 is a schematic diagram of a display circuit and a fingerprint recognition circuit in a pixel in a second display area of the display device.

FIG. 6 is a schematic diagram showing a working process of both the display device and a driver according to an embodiment of the present disclosure.

FIG. 7 is a flow chart of a driving method according to an embodiment of the present disclosure.

FIG. 8 is a schematic diagram showing a working process of the driver according to another embodiment of the present disclosure.

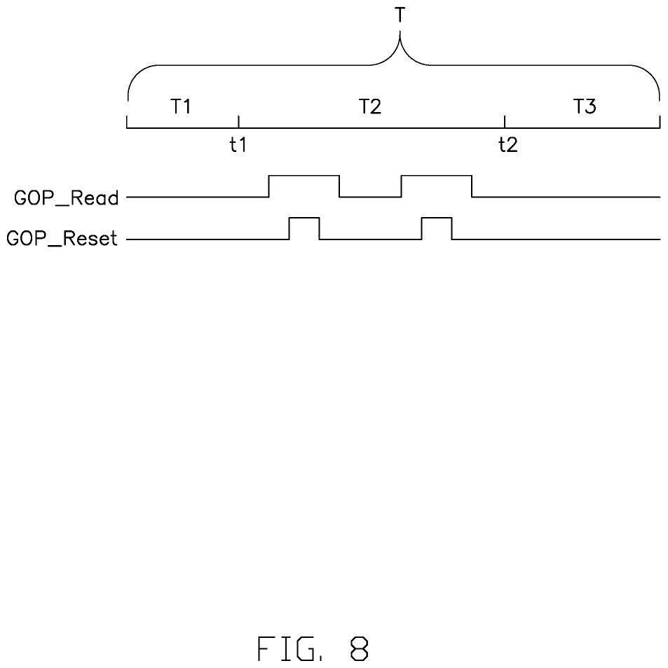

### DETAILED DESCRIPTION

It will be appreciated that for simplicity and clarity of illustration, where appropriate, reference numerals have been repeated among different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series, and the like.

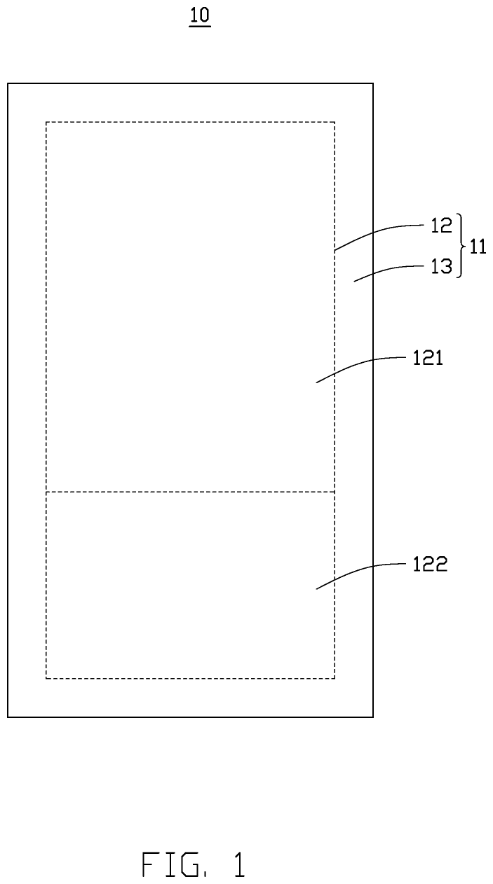

Referring to FIG. 1, a display device 10 in the present embodiment is configured to display images. The display device 10 may be a smartphone, a tablet computer, or the like. The display device 10 provided in the present embodiment is a smartphone. Specifically, the display device 10 provided in the present embodiment can both display images and recognize fingerprints.

Referring to FIG. 1, the display device 10 defines a display area 12 and a non-display area 13. The display area 12 is surrounded by the non-display area 13. The display area 12 is configured to display images. The non-display area 13 is opaque. A portion of the display device 10 covered by the non-display area 13 is configured for carrying wiring, circuits, and the like.

Refer to FIG. 1, the display area 12 includes a first display area 121 and a second display area 122. The first display area 121 and the second display area 122 are adjacent to each other and independent from each other. In the present embodiment, the first display area 121 and the second display area 122 are both rectangular. The first display area 121 and the second display area 122 together form a rectangular display area 12. The first display area 121 is configured for displaying images. The second display area 122 can display images and accept impressions of a fingerprint.

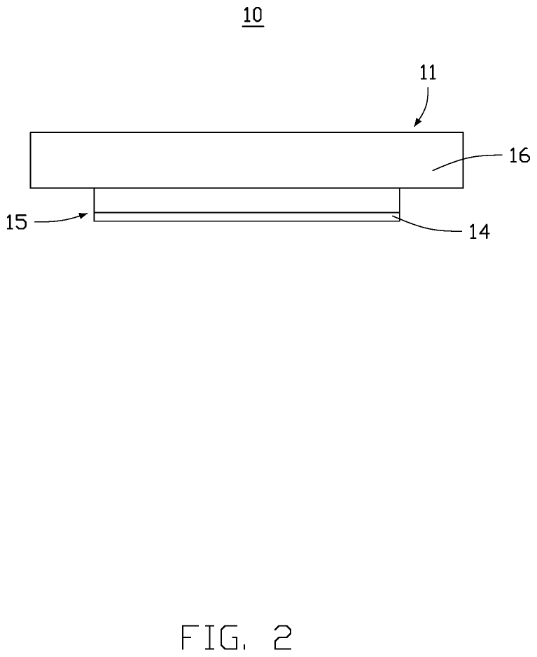

Referring to FIG. 2, the display device 10 includes a display panel 15 and a cover plate 16 stacked on the display panel 15. The cover plate 16 has a surface 11 away from the display panel 15. The display panel 15 includes a driving substrate 14 for driving the display panel 15 to display images. The display panel 15 is further configured to receive fingerprints when a finger is touching in the second display area 122. In the present embodiment, the display panel 15 is a liquid crystal display panel. In other embodiments, the display panel 15 may be a light-emitting diode display panel or the like. The display panel 15 further includes other structures (for example, a liquid crystal layer, a color filter substrate, etc.), but only structures related to the present embodiment will be described here.

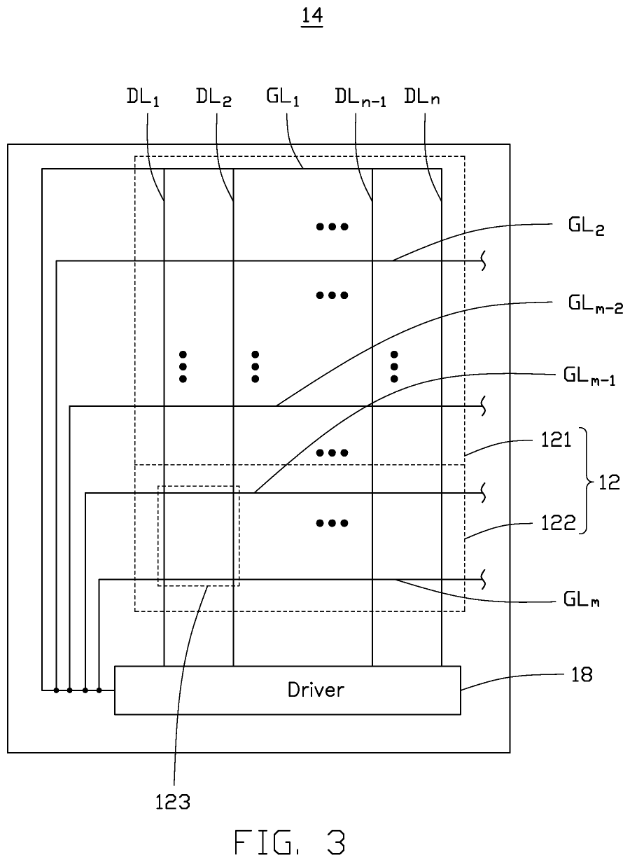

Referring to FIG. 3, a plurality of gate lines (including gate lines GL₁˜GLₘ) and a plurality of data lines (including data lines DL₁˜DLₙ) are provided on a surface of the driving substrate 14. The gate lines GL are parallel to each other. A part of the plurality of gate lines GL is located in the first display area 121, and another part of the plurality of gate lines GL is located in the second display area 122. The data lines DL are parallel to each other. Each data line DL extends from the first display area 121 to the second display area 122. The gate lines GL and the data lines DL cross each other but are electrically insulated from each other.

Referring to FIG. 3, adjacent gate lines GL and adjacent data lines DL define a pixel 123. Referring to FIG. 2 and FIG. 3, the display area 12 defines a plurality of pixels 123 arranged in an array of rows and columns. A portion of the pixels 123 is arranged in the first display area 121, and another portion of the pixels 123 is arranged in the second display area 122.

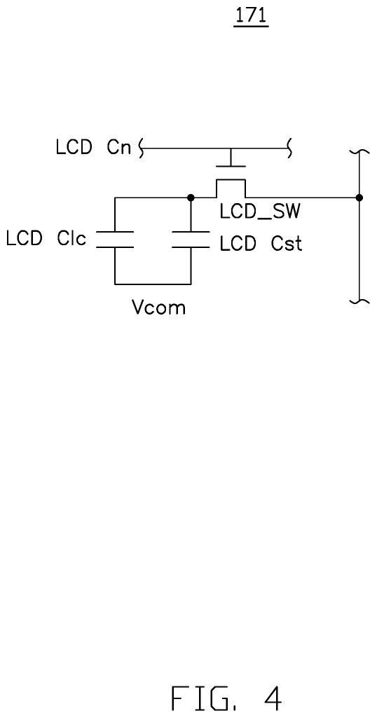

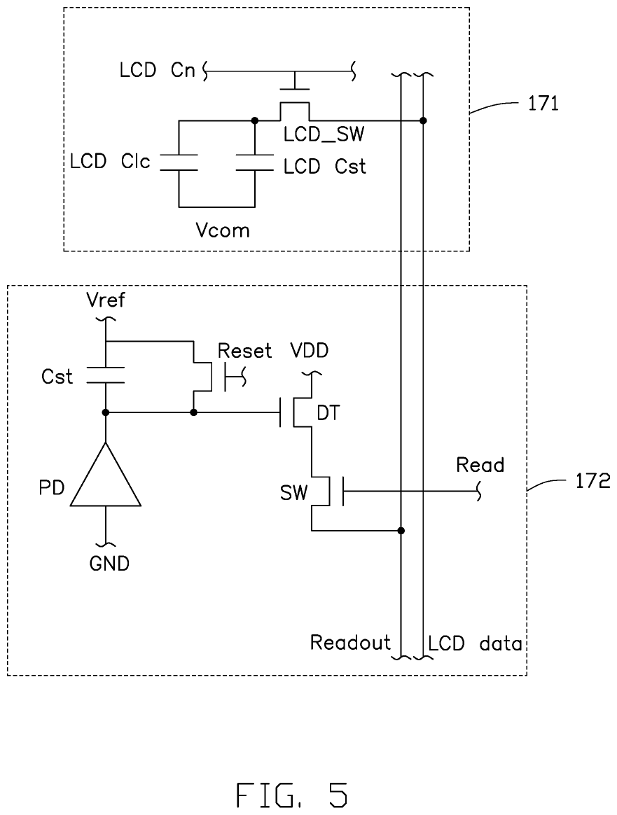

Referring to FIG. 4, each pixel 123 in the first display area 121 is provided with a display circuit 171. The display circuit 171 is located on the driving substrate 14. Referring to FIG. 5, at least some of the pixels 123 in the second display area 122 are provided with a display circuit 171 and a fingerprint recognition circuit 172. In the present embodiment, the second display area 122 includes a fingerprint recognition area. When a finger touches the fingerprint recognition area, the display device 10 can generate signals accordingly. Each pixel 123 within the fingerprint recognition area in the second display area 122 is provided with the display circuit 171 and the fingerprint recognition circuit 172. A pixel 123 which is not within the fingerprint recognition area in the second display area 122 is provided only with the display circuit 171.

Referring to FIG. 3, each gate line GL electrically connects to multiple display circuits 171, wherein such display circuits 171 are located in pixels 123 that are arranged in a same row of the pixel array. Each data line DL electrically connects to multiple display circuits 171, wherein such display circuits 171 are located in pixels 123 that are arranged in the same column of the pixel array.

Referring to FIG. 3, the driving substrate 14 further includes a driver 18. The driver 18 is electrically connected to each gate line GL, each data line DL, each display circuit 171, and each fingerprint recognition circuit 172. The driver 18 drives each display circuit 171 to display images. The same driver (driver 18) drives each fingerprint recognition circuit 172 to accept fingerprints.

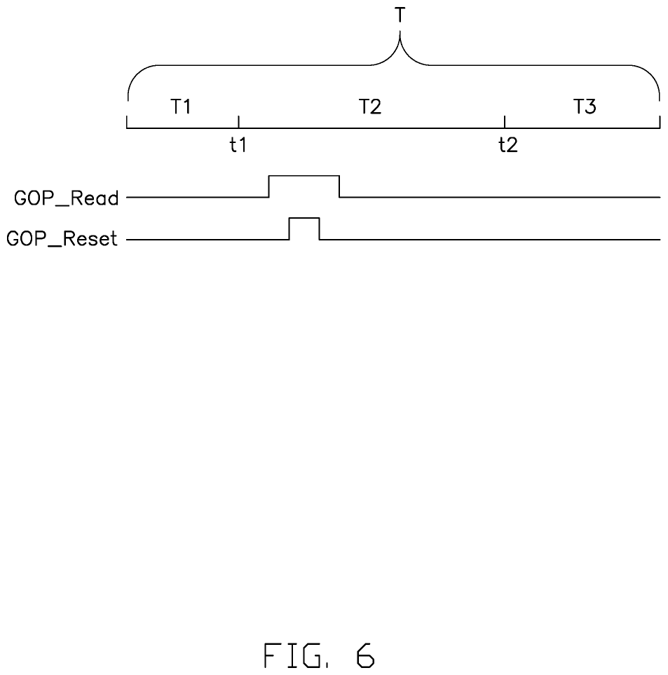

Referring to FIG. 6, the display device 10 works in operation periods T. The driver 18 operates in first driving periods T1, second driving periods T2, and third driving periods T3 within operation period T. In each operation period T, one first driving period T1, one second driving period T2, and one third driving period T3 appear in sequence.

The following describes a driving method applied to the display device 10. In the present embodiment, the driving method is applied to the driver 18.

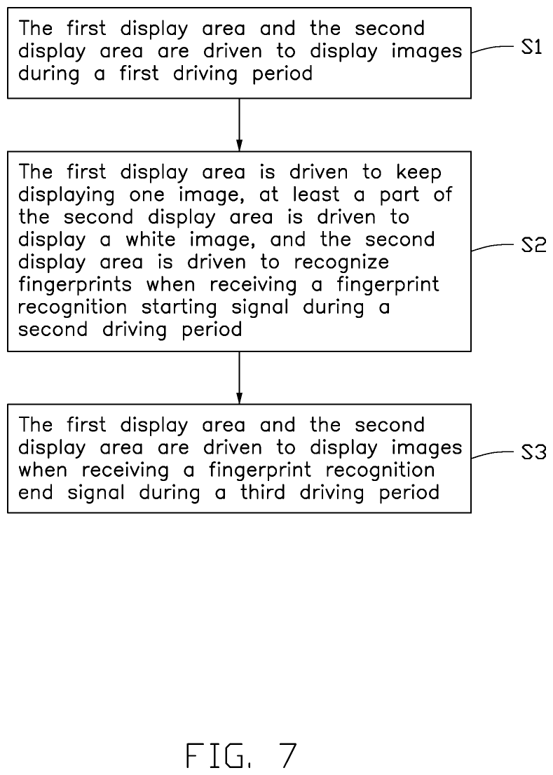

Referring to FIG. 7, a flowchart of such a method is presented in accordance with an example embodiment. The example method is provided by way of example, as there are a variety of ways to carry out the method. Each block shown in FIG. 7 represents one or more processes, methods, or subroutines, carried out in the exemplary method. Additionally, the illustrated order of blocks is by example only and the order of the blocks can change according to the present disclosure.

At block S1, the first display area and the second display area are driven to display images during a first driving period.

At block S2, the first display area is driven to keep displaying one image, at least a part of the second display area is driven to display a white image, and the second display area is driven to recognize fingerprints when receiving a fingerprint recognition starting signal during a second driving period.

At block S3, the first display area and the second display area are driven to display images when receiving a fingerprint recognition end signal during a third driving period.

Referring to FIG. 6, in the first driving period T1, the driver 18 outputs gate driving signals to the gate lines GL₁˜GLₘ, and outputs image signals to the data lines DL₁˜DLₙ, wherein the data lines DL₁˜DLₙ, output image data to each display circuits 171 to drive the display device 10 to display images.

In the present embodiment, the driver 18 sequentially outputs the gate driving signals to gate line GL₁ to date line GLₘ in order, which can be called “scanning”. The display device 10 displays one frame of an image when the driver 18 gives a complete scanning of the gate lines GL₁ to GLₘ. The display device 10 displays images at a first frequency during the first driving period T1. In the present embodiment, the first frequency is 60 Hz, that is, the display device 10 displays sixty frames of an image within one second. There is a time interval between each consecutive frame of an image. The display device 10 does not display images during the time interval. In the present embodiment, the duration of the time interval between each consecutive frame of image is the same.

In the first driving period T1, the first display area 121 and the second display area 122 display images together according to the image signals (or the image data). That is, in the first driving period T1, a part of each frame of the image displayed by the display device 10 is displayed by the first display area 121, and the other part is displayed by the second display area 122. Taking the orientation shown in FIG. 1 as an example, an upper part of each frame of the image displayed by the display device 10 is displayed by the first display area 121, and a lower part is displayed by the second display area 122.

Referring to FIG. 6, at a first time t1, the driver 18 receives a fingerprint recognition start signal, and then the driver 18 enters the second driving period T2 which is the period for fingerprint acceptance. In the present embodiment, the time when the driver 18 receives the fingerprint recognition start signal is within the time interval, that is, the first time t1 is within the time interval, so that a frame of the image displayed before the first time t1 is not affected.

In the present embodiment, the fingerprint recognition starts signal is a signal generated by the display device 10 after the surface 11 detects a touch in the fingerprint recognition area.

During the second driving period T2, the display area 12 stops updating images. The driver 18 stops updating the image signals outputting to the data lines DL₁˜DLₙ. Specifically, the driver 18 controls the data lines DL₁˜DLₙ to output image data to each display circuit 171 in the first display area 121 to keep the first display area 121 displaying a most recent frame of the image. The driver 18 controls the data lines DL₁˜DLₙ to output a same image data to each display circuit 171 in the second display area 122, so as to control the second display area 122 to display a white image. The white image displayed by the second display area 122 provides a light source for recognizing a fingerprint (the light source reflected by a finger enables a recognition of the finger).

In other embodiments, during the second driving period T2, the driver 18 controls a portion of the pixels 123 in the second display area 122 to display a white image. In addition, the driver 18 controls the data lines DL₁˜DLₙ to output same image data to the display circuits 171 in a row of pixels 123 of the pixel array, wherein the row of pixels 123 is the farthest row from the first display area 121, so that such row of pixels 123 displays a white image, or a black image, or a gray image, to reduce interference with the image signals for fingerprint recognition.

Referring to FIG. 6, during the second driving period T2, the driver 18 outputs fingerprint recognition driving signals (GOP_Reset) and (GOP_Read) to each fingerprint recognition circuit 172. The driver 18 receives fingerprint sensing signals (Readout) (see FIG. 5) and recognizes fingerprints from the fingerprint sensing signals (Readout). The processes of receiving the fingerprint sensing signals (Readout) and recognizing the same are known in the art.

A process of outputting the fingerprint identification driving signals (GOP_Reset) and (GOP_Read) shown in FIG. 6 is a fingerprint scanning cycle. A duration of one scanning cycle is the same as a duration of displaying a frame of image in the first driving period T1, which simplifies a signal outputting process of the driver 18.

In other embodiments, the duration of one scanning cycle may not be the same. In other embodiments, referring to FIG. 7, the second driving period T2 can be extended to achieve multiple scanning cycles in the second driving period T2.

There is one time interval between each consecutive frame of the image. Each second driving period T2 for recognizing fingerprints is within one time interval. A longer duration of the second driving period T2 enables better fingerprint recognition. Such a longer duration reduces frequency of displaying images. Therefore, the display device 10 displays images at the first frequency during the first driving period T1, and displays images at the second frequency during the second driving period T2, wherein the second frequency is lower than the first frequency. In the present embodiment, the first frequency is 60 Hz, the second frequency is 30 Hz. The stated first frequency and the stated second frequency can be different in other embodiments. The specific second frequency as a value is determined according to a duration of the second driving period T2. In addition, the specific value of the second frequency is determined according to a duration of the scanning period and the number of scanning periods.

In the present embodiment, the display device 10 keeps displaying images at the second frequency during the second driving period T2. In other embodiments, the display device 10 displays images at the second frequency when the fingerprint recognition drive signals (GOP_Reset) and (GOP_Read) are outputted, and displays images at the first frequency when there is an absence of fingerprint recognition drive signals (GOP_Reset) and (GOP_Read). Simplifying a signal outputting process of the display device 10 in this way also reduces a number of switchings between the first frequency and the second frequency.

At the second time t2, the driver 18 receives a fingerprint recognition end signal, and then the driver 18 enters the third driving period T3. In the present embodiment, a time when the driver 18 receives the fingerprint recognition end signal is outside the scanning cycle, this avoids affecting the fingerprint recognition.

In the third driving period T3, a working process of the driver 18 is basically the same as that in the first driving period T1.

The driving method, the driver 18, and the display device 10 provided by the present embodiment avoids the fingerprint acceptance signals interfering with the image signals; the first display area 121 and the second display area 122 are driven to display images during the first and third driving periods T1 and T3, the first display area 121 displaying a most recent frame of the image, the second display area 122 displaying a white image, and the second display area 122 able to accept and recognize fingerprints during the second driving period T2.

It is to be understood, even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

1. A driving method of a display device for displaying images, the display device defining a first display area and a second display area independent from each other, the driving method comprising:
driving the first display area and the second display area to display images at a first frequency during a first driving period;
driving the first display area to display images at a second frequency during at least a part of a second driving period so the first display area keep displaying one image during the second driving period, driving at least a part of the second display area to display a white image, and driving the second display area to recognize fingerprints when receiving a fingerprint recognition starting signal during the second driving period, the first frequency being twice the second frequency; and
driving the first display area and the second display area to display images when receiving a fingerprint recognition end signal during a third driving period.

2. The driving method of claim 1, wherein driving the first display area to keep displaying one image comprises:
driving the first display area to keep displaying a last frame of the image before receiving the fingerprint recognition start signal.

3. The driving method of claim 2, wherein the display device further comprises a plurality of pixels arranged in an array comprising a plurality of rows and columns;
wherein a row of the plurality of pixels in the array farthest from the first display area display a white image, a black image, or a gray image during the second driving period.

4. (canceled)

5. The driving method of claim 1, wherein driving the first display area and the second display area to display images during at least a part of the second period at a second frequency comprises:
driving the first display area and the second display area to display images during the entire second driving period at the second frequency.

6. The driving method of claim 5, wherein the display device further comprises a plurality of pixels arranged in an array comprising a plurality of rows and columns;
wherein a row of the plurality of pixels in the array farthest from the first display area display a white image, a black image, or a gray image during the second driving period.

7. The driving method of claim 5, wherein a duration of recognizing the fingerprints in the second driving period is the same as a duration of displaying a frame of the image in the first driving period.

8-12. (canceled)

13. The driving method of claim 1, wherein a time when the fingerprint recognition start signal is received and a time when the fingerprint recognition end signal is received are in a time interval between consecutive frames of images displayed by the display device.

14. A display device comprising:
a display panel defining a first display area and a second display area independent from each other, the display panel comprising a driving substrate for driving the display panel to display images, a driver being on the driving substrate;
wherein the driver is configured to drive the first display area and the second display area to display images at a first frequency during a first driving period, to drive the first display area to display images at a second frequency during at least a part of a second driving period so the first display area keep displaying one image, drive at least a part of the second display area to keep displaying a white screen, drive the second display area to recognize a fingerprint when receiving a fingerprint recognition start signal during the second driving period, the first frequency being twice the second frequency, and to drive the first display area and the second display area to display images when receiving a fingerprint recognition end signal in a third driving period.

15. The display device of claim 14, wherein the driver is further configured to receive the fingerprint recognition start signal during the second driving period, and to drive the first display area to keep displaying an image of the last frame before receiving the fingerprint recognition start signal.

16. The display device of claim 15, wherein the display device comprises a plurality of pixels arranged in an array comprising a plurality of rows and columns;
wherein a row of the plurality of pixels in the array farthest from the first display area display a white image, a black image, or a gray image during the second driving period.

17-19. (canceled)
